(19) United States
(12) Patent Application Publication
(10) Pub. No.: US 2006/0163522 A1
(43) Pub. Date: Jul. 27, 2006

(54) Apparatus and method for supporting a memeber and controlling flow

(76) Inventors: Paul Gallagher, Altavista, VA (US); Harold Anthony Staples III, Irvine, CA (US); Robert Miller, Irvine, CA (US)

Correspondence Address: MORRISON & FOERSTER, LLP, 555 WEST FIFTH STREET, SUITE 3500, LOS ANGELES, CA, 90013-1024, US

(21) Appl. No.: 11/329,684

(22) Filed: Jan. 10, 2006

Related U.S. Application Data
(60) Provisional application No. 60/642,796, filed on Jan. 10, 2005.

(51) Int. Cl. F16K 25/00

(52) U.S. Cl. 251/368

(57) ABSTRACT

A material is used in an apparatus that regulates a fluid to provide sufficient support for a member, such as a seal, yet allow the passage of the fluid in a passageway. The material can be a porous metal which is placed in the passageway so as to be closely aligned with the passageway's opening. The placement of the porous metal at or near the opening allows the seal to rest on the cross-section of the passageway as well as on the support provided by the porous metal. The increase in surface area upon which the seal is support reduces the risk that the seal will be cut and/or abraded, particularly in high pressure environments. The use of the material is the passageway further provides design control over the flow of the fluid.

### CROSS REFERENCE TO RELATED APPLICATION

The present invention claims the benefit under 35 USC 119(e) of U.S. Provisional Application Ser. No. 60/642,796 filed Jan. 10, 2005, the contents of which are incorporated by reference herein.

### BACKGROUND OF THE INVENTION

The present invention relates to an apparatus and method for supporting a member and, additionally, controlling a flow of a fluid.

FIG. 1 illustrates a detailed view of a conventional pilot operated solenoid valve. The detailed view illustrates the arrangement between the armature 1 and the pilot spool 3. The pilot spool 3 has a passageway 7 for bleeding a gas away from the main spool (which is not illustrated in FIG. 1) through passageway 8. Passageway 7 includes a short extension, known as a sealing spud 4, beyond the top surface of the pilot spool 3. The sealing spud has an annular cross-section defined by the internal diameter D₂ of passageway 7 and the external diameter D₁ of sealing spud 4. Seal 2 rests on the sealing spud 4 when the armature 1 is in a de-energized state. In the de-energized state, seal 2 prevents pressurized gas 6 surrounding the pilot spool 3 from entering the opening of passageway 7. When the armature 1 is energized, seal 2 is lifted from the sealing spud 4 to allow gas to flow through the opening of passageway 7 and into passageway 8.

For the armature 1 to lift seal 2 from the sealing spud 4, it must overcome at least two loads. The first load is from the spring 5 which urges seal 2 against the sealing spud 4. The second load is related the pressure of the pressurized gas 6. The pressurized gas 6 seeks to enter passageway 7 when seal 2 rests on the sealing spud 4. Accordingly, a force equivalent to the area of the sealing spud (based on its external diameter D₁) multiplied by the pressure of the gas 6 is required to lift seal 2 from the sealing spud 4. The external diameter D₁ of the sealing spud 4 is typically minimized to reduce the second load that the armature 1 must overcome.

The pilot operated solenoid valve has several limitations, particularly in a high pressure environment such as 10,000 psi.

First, a high pressure environment requires the external diameter D₁ of the sealing spud to be fully minimized, otherwise the load on the armature 1 will be too large. As discussed above, the cross-section of the sealing spud is an annular ring defined by the internal diameter D₂ of the passageway and the external diameter D₁ of the sealing spud. Minimizing the external diameter D₁ of the sealing spud reduces the surface area of the annular ring upon which the seal rests. The seal is preferably made of a resilient material to provide leak integrity over a wide range of pressures and temperatures. It has been discovered that a sealing spud having a reduced cross-sectional surface area will cut and/or abrade the seal during operation, particularly in a high pressure environment.

FIG. 2 shows an actual seal 2 used in a 10,000 psi environment. (The reference numeral 2 is repeated merely to provide context with respect to FIG. 1.) The seal exhibits a distinct cut area 9. The cut area 9 is annular corresponding to the small annular cross-section of the sealing spud.

A second limitation of a pilot operated solenoid valve is sizing the pilot spool orifice vis-à-vis the main spool orifice to ensure proper operation. FIG. 3 illustrates an expanded detailed view of the pilot-operated solenoid valve of FIG. 1. (Identical reference numerals in FIGS. 1 and 3 refer to the same structure.) FIG. 3 shows an arrangement in which the pilot spool 3 is not part of the main spool 13. The pilot spool 3 and the main spool 13 are instead separated and connected through passageways. Pressurized gas initially flows through passageway 16, passageway 15 and the main spool bleed orifice 14. The main spool 13 is positioned in a chamber 19 through which the pressurized gas flows. The pressurized gas then surrounds the pilot spool 3 through passageway 11.

When the armature 1 is energized by solenoid coils 20, the seal 2 is lifted from the sealing spud 4, and the pressurized gas around the pilot spool enters the opening of passageway 7. Passageway 7 acts as a bleed orifice to bleed the gas from the system through passageways 8 and 10 to outlet. This creates a pressure differential across the main spool bleed orifice 14. The pressure differential ultimately results in the main spool overcoming a load (which includes the load provided by spring 12) to lift seal 17. Pressurized gas then enters passageway 18 which communicates with the outlet port.

It is imperative that the flows through passageway 7 acting as a pilot spool bleed orifice and the main spool orifice 14 be carefully engineered to ensure the correct pressure differential. For example, if the ratio between the diameter of passageway 7 and main spool bleed orifice 14 is too small, the pressurized gas will bleed through the main spool bleed orifice 14 toward passageway 7 at a flow rate that does not create the necessary pressure differential to lift the main spool 13. Accordingly, it is necessary to utilize precisely sized orifices. Such close tolerance control increases costs and is prone to manufacturing error.

### BRIEF SUMMARY OF THE INVENTION

The above limitations are overcome through the use of a material that provides sufficient support for a member yet allows the passage of a fluid. As an example, the material can be a porous metal. The porous metal can be placed in an annular passageway so as to be closely aligned with the passageway's opening. The placement of the porous metal at or near the opening allows the seal to rest not only on the annular cross-section of the passageway, but also on the support provided by the porous metal. This increases the surface area upon which the seal can rest and be supported. The increase in surface area, in turn, reduces the risk that the seal will be cut and/or abraded, particularly in high pressure environments.

Furthermore, the increase in surface area is obtained without altering the dimensions of the annular passageway. This is particularly advantageous in high pressure environments, where a dimensional alteration may dramatically increase the load on the armature. With the use of the porous metal, there is no need to increase the external diameter of the passageway, thereby avoiding any increase in the load on the armature. In other words, the external diameter of the passageway can be maintained at a minimal size without fear that the seal will be cut and/or abraded during operation.

Nor is there a need to make costly alterations to the flow of the system to increase the cross-sectional surface area upon which the seal rests. For example, the cross-sectional surface area can be increased by reducing the internal diameter of the annular passageway vis-à-vis the external diameter. While the overall size of the passageway does not change (because the external diameter has not been changed), the reduced internal diameter of the passageway changes the flow rate through the passageway. This may require changing the bleed rates of other passageways in the whole system. However, the use of porous metal provides an increase in surface area without dramatically altering the flow of the fluid through the passageway or allowing the flow of the fluid to be altered as desired. The porosity of the metal allows the fluid to flow through the passageway in any manner dictated by the apparatus, system or operation.

Indeed, an additional feature of the present invention is that the placement of a porous metal in the passageway provides design control over the flow of the fluid in the passageway and, if desired, through the whole system. For example, two metals of different porosity can be placed in the pilot spool bleed passageway and a main spool bleed passageway, respectively. The difference in porosity can be used to establish and maintain the correct relationship between the flow rates of the two passageways. In this manner, it is not necessary to exercise close tolerance control over the passageways, because the porous metals provide the correct relationship.

The present invention is directed to an apparatus, a method and a method of making a product.

One apparatus is an apparatus for regulating a fluid. The apparatus comprises a passageway for carrying the fluid, the passageway having an opening, and a member operating between a first and second position to regulate the fluid. At the first position, the fluid flows through the passageway and, in the second position, the fluid is prevented from flowing through the passageway. The apparatus comprises a material positioned in relation to the opening to provide support for the member while in the second position and allow the fluid to flow through the passageway when the member is in the first position. The apparatus may have the material positioned within the opening of the passageway. Alternatively, the apparatus may have the material positioned around the opening of the passageway. The material may be configured to have any given cross-section and depth. The material may be composed of a porous metal.

One method is a method for supporting a member regulating a fluid by increasing the surface area upon which the member sits. The method may further comprise associating a material with a passageway upon which the member sits. The method may further comprise associating the material with the passageway by placing the material within the passageway. The method may further comprise using a material that allows the fluid to flow through the material.

Another method is regulating a fluid by placing a first material in association with a first passageway and a second material in association with a second passageway, such that the first material supports a member associated with the first passageway, and configuring the first and second materials to regulate the flow rates between the two passageways. The method may further comprise configuring the first and second materials by choosing a composition of each material. The method may further comprise configuring the first and second materials by determining the porosity of each material. The method may further comprise configuring the first and second materials by defining the desired depth and cross-section for each material. The method may further comprise configuring the first and second materials by determining the placement of each material in relation to each respective passageway. The method may further comprise adding a third material to be associated with the first passageway.

One method of making a product is a method of making an apparatus for regulating a fluid. The method comprises inserting a material in a passageway in which the fluid flows, and processing the material in the passageway such that the material provides support to a member associated with the passageway and allows the fluid to flow through the passageway. The method may further comprise processing the material by sintering the material. The method may further comprise using a metal as the material.

These and other features and advantages of the present invention will be apparent to those skilled in the art from the following detailed description, when read with the drawings.

### BRIEF DESCRIPTION OF THE SEVERAL VIEWS OF THE DRAWINGS

FIG. 1 illustrates a detailed view of a conventional pilot operated solenoid valve.

FIG. 2 shows an actual seal used in a high pressure environment.

FIG. 3 illustrates an expanded detailed view of the pilot-operated solenoid valve of FIG. 1

FIG. 4 illustrates a detailed view of an apparatus for regulating a fluid.

FIG. 5 illustrates a detailed view of an apparatus for regulating a fluid having at least two passageways.

FIG. 6 illustrates a view of pilot-operated solenoid valve.

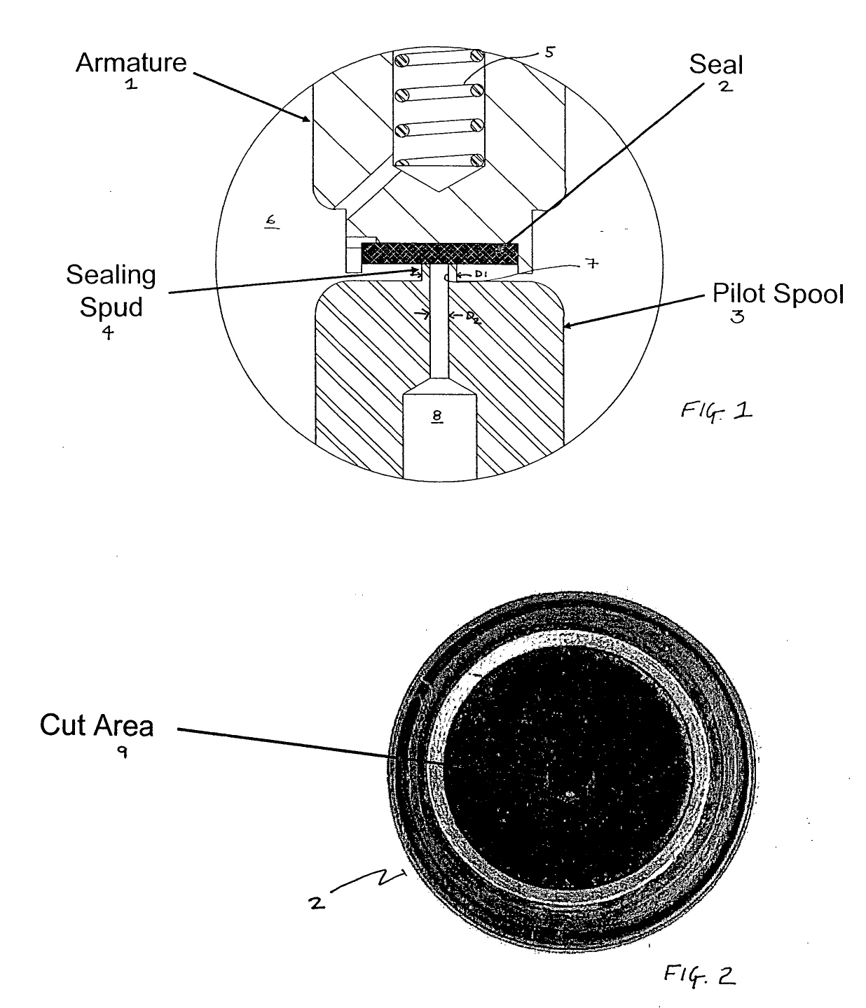

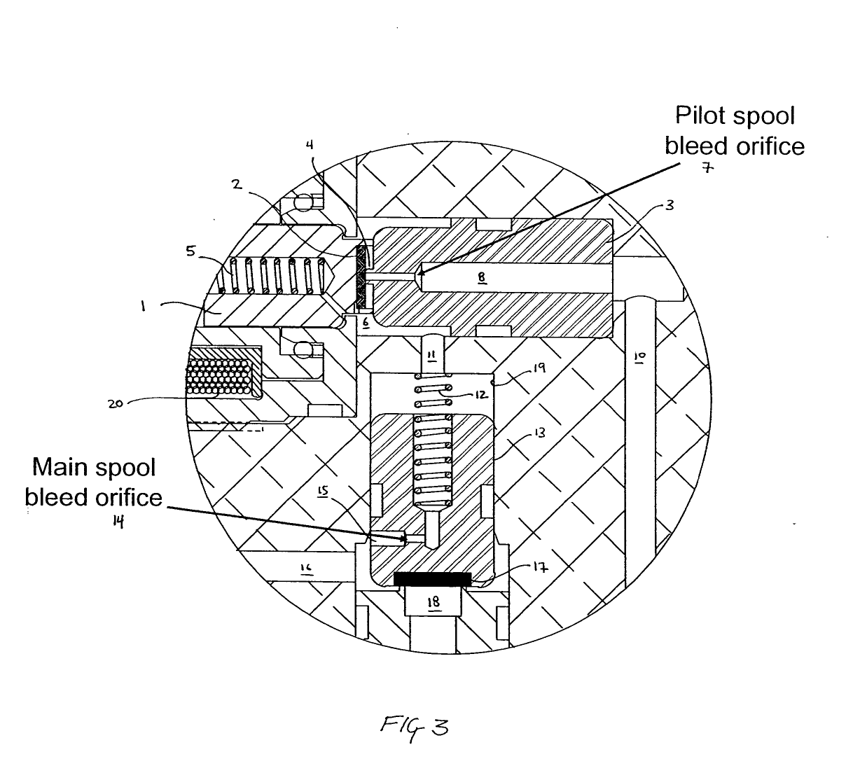

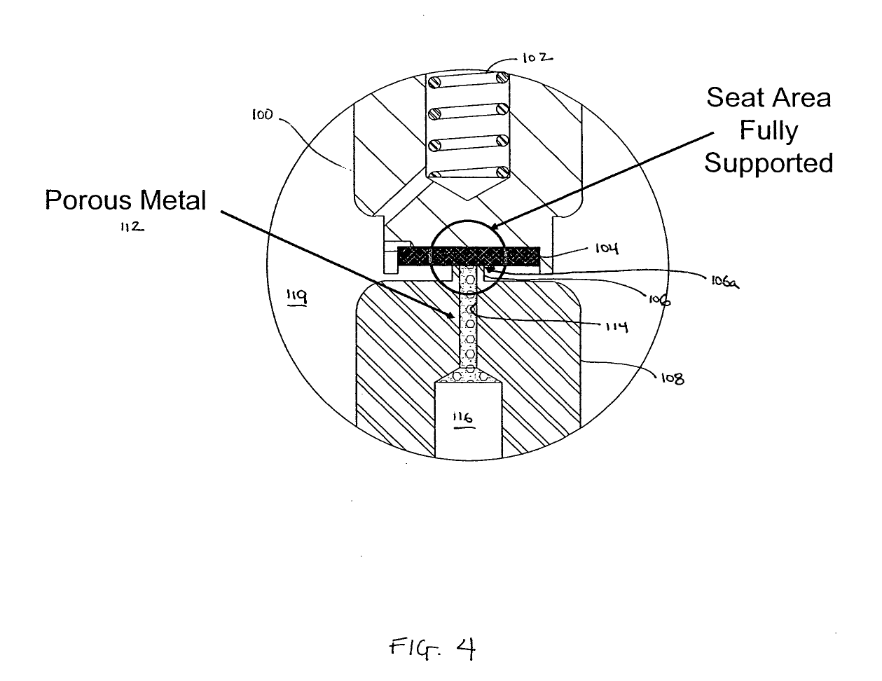

### DETAILED DESCRIPTION OF THE INVENTION

FIG. 4 illustrates an apparatus for regulating a fluid. The apparatus comprises a body 108. Extending from the surface of body 108 is an annular extension 106. A passageway 114 extends from the top surface 106a of the annular extension 106 through the body 108 to communicate with a larger passageway 116. It should be noted that annular extension 106 is not necessary. The surface of body 108 can be flush with an opening for passageway 114.

The apparatus further comprises a material 112 placed within the entire internal cross-section of passageway 114. The material is placed in passageway 114 such that the material is closely aligned with the top surface 106a of the annular extension 106. It can be flush with the top surface 106a of the annular extension 106 or at a distance from the top surface 106a. The material 112 is further placed to extend through passageway 114 and into passageway 116.

Material 112 provides support for a member 104 (such as a seal) while allowing a fluid to flow through passageway 114. Specifically, the apparatus of FIG. 4 is surrounded by a fluid, such as gas 119. When the armature 100 is de-energized, spring 102 urges seal 104 against the annular extension 106 to prevent the gas 119 from entering passageway 114. Seal 104, which can be made of a resilient material, is supported not only by the annular cross-section of extension 106 but also by material 112 that is closely aligned with the top surface 106a of extension 106. In this manner, the risk of cutting and/or abrading seal 104 is minimized. When the armature 100 is energized, seal 104 is lifted to allow the gas 119 to flow through passageway 114. Material 112 allows gas 119 to flow through passageway 114.

By placing a material in a passageway that provides support for a member while allowing a fluid to flow through the passageway, the surface area supporting the member is beneficially increased without altering any of the dimensions of the passageway or negatively affecting the sealing diameter.

It should be noted that FIG. 4 illustrates only one configuration for placing material 112 in passageway 114. Other configurations can be used. For example, material can be placed in a passageway such that the material only fills a longitudinal portion of the passageway as opposed to filling the entire length of the passageway 114 as illustrated in FIG. 4. Also, the material can placed in the passageway to have a cross-sectional area that is less than the cross-sectional area of the passageway. One such configuration creates an annular ring in the passageway that is free of any material.

Indeed, the material can be positioned in locations other than the passageway. In one configuration, material can be placed on the outside of an extension. For example, material 112 can be placed around the periphery of extension 106. In one such configuration, material 112 would be positioned in the shape of dough-nut around extension 106. This configuration provides support for the seal without dramatically affecting the load on the armature or increasing the dimensions of the passageway itself. It should be noted that the material can be placed both outside the passageway and inside the passageway. The combination of material both inside and outside the passageway maximizes the support that can be provided to a member.

Material 112 can be any material that provides structure while allowing a fluid to flow. To allow fluid through a passageway, the material can be porous or permeable. FIG. 4 illustrates the material as a porous metal (along with the appropriate shading in passageway 114). Alternatively, the material can be non-porous such that fluid flows around the material in the passageway. For example, thin rods or small beads can be placed in the passageway to provide support yet allow fluid to flow through the passageway.

As discussed, FIG. 4 illustrates the use of a metal. The metal can be, without limitation, 316 stainless steel. It should be noted that non-metal materials can be used as well. For example and without limitation, plastics or porous Teflon (trademarked) can be used. Indeed, even non-solid materials can be used such as, without limitation, porous gels.

Material is placed in a passageway through a series of steps. If the material is to be a porous metal as in material 112 of FIG. 4, a powdered metal is first selected. The type of the powder metal will affect the porosity of the resulting metal 112. Then, the selected powdered metal is placed into passageway 114. The amount of powdered metal in passageway 114 will also affect the porosity of the resulting metal 112 as well its placement in the passageway. FIG. 4 illustrates the porous metal 112 extending into passageway 116, but any depth can be set as well as any cross-sectional width. The powdered metal then is compressed and baked in a manner well known to one of ordinary skill in the art. For example, the powdered metal can be baked in excess of 800° C. At this temperature, the powdered metal will become sintered. The sintered metal is fixedly positioned in the passageway as porous metal 112.

Other methods can be utilized to provide a material that provides support for a member yet allows fluid to flow through the passageway. For example, a solid, one piece material can be made into a porous passageway through the use of a laser. The laser can be used to emit laser beams having the width of 5 to 10 microns onto the solid, one piece material. The beams create holes in the material to create a porous passageway. Indeed, any method known to one of ordinary skill the art that creates a porous passageway can be used.

An additional feature of the present invention is that the use of material that supports a member yet allows fluid to flow through a passageway provides design control over the flow of the fluid in that passageway. For example, in FIG. 4, the porosity and the placement of the metal 112 can be selected to provide the desired flow of the fluid in passageway 114. This is beneficial for a number of reasons.

First, there is no need to utilize close tolerance control on the passageway. Material of the desired porosity can be selected and then placed in a desired configuration to create the necessary flow rate. Second, adjustments can be made to the flow rate of the passageway without altering the dimensions of the passageway. If the flow rate of the passageway needs to be adjusted, material can be added to the passageway or the porosity or placement of material already in the passageway can be re-configured to provide the newly desired flow rate. There is no need to provide expensive retrofitting of the passageway.

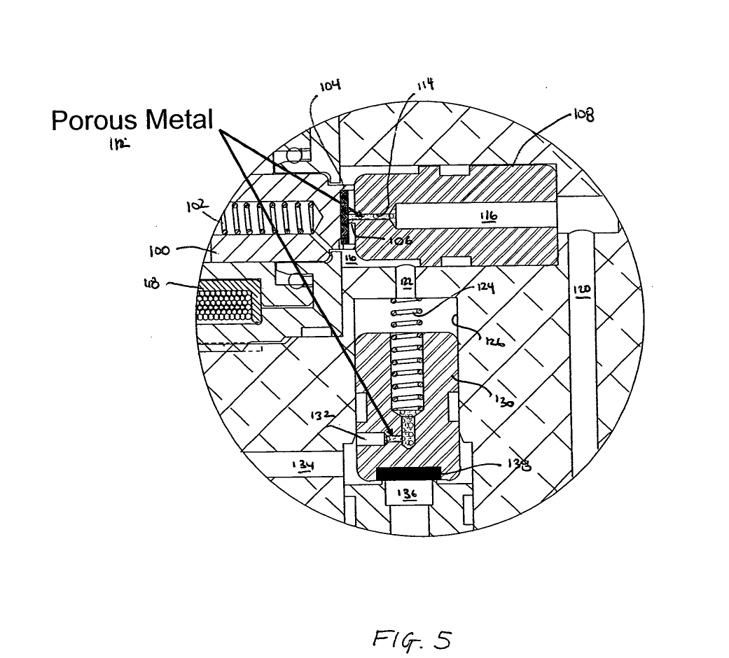

The ability of the material to provide design control is particularly advantageous when the apparatus includes at least two passageways and the correct relationship between the flow rates in the passageways must be established. FIG. 5 illustrates a detailed view of an apparatus for regulating a fluid having at least two passageways where the flow rates between the two passageways must be established. (FIG. 5 utilizes some of the same reference numerals as in FIG. 4 to merely provide context. FIG. 4 and FIG. 5 can be different apparatuses.)

The apparatus of FIG. 5 comprises two passageways 114 and 135 where the flow rates between the two passageways must be established. This is due to the operation of the apparatus. A pressurized fluid, such as a gas, enters the detailed area through passageway 134. The gas flows through passageway 132, through passageway 135, through chamber 126, through passageway 122 and into passageway 110. When the armature 100 is energized by solenoid coils 118, member 104 (which can be a seal) is lifted from extension 106 on which it rests. The pressurized gas flows through passageway 114 in body 108 and then flows through passageways 116 and 120 to outlet.

As the gas bleeds through passageway 114, gas also bleeds through passageway 135. To create the necessary pressure drop, the flow of the gas through passageway 114 must be faster than the flow of the gas through passageway 135. A pressure drop is created in this situation, because gas is flowing out to outlet at a greater rate than it can be replaced. The pressure drop overcomes the load (including the load provided by spring 124) on body 130 and body 130 lifts in chamber 126. The lifting of body 130 correspondingly lifts member 138, such that the pressurized gas enters passageway 136.

It is important that the flow rates between passageway 114 and passageway 135 be established and maintained to create the proper pressure differential to lift body 130. For example, if the flow rate of passageway 135 is too high, an appropriate pressure drop is not created, thereby not allowing body 130 to overcome its load.

FIG. 5 shows the use of a porous metal 112 that allows a fluid to flow through passageways 114 and 135. The material 112 is placed in each passageway in such a manner to create the desired flow rate for each passageway, such as by attenuating the flow in each passageway. For example, the material 112 in passageway 114 can have a different porosity than the material 112 in passageway 135 so as to achieve the necessary difference in flow rates between the passageways. In this manner, the porous metal can support a member such as 106 and also provide design control over the flow of the apparatus. Moreover, there is no need for precise tolerance control of passageway 114 and 135, because the flow in each passageway can be controlled through the use of porous metal 112.

FIG. 5 shows both the placement and type of the material used in the apparatus of FIG. 5. It should be noted that placement of the material and the type of material can be in any other configuration discussed above with respect to FIG. 4. FIG. 5 shows the same material used in both passageways. However, the material for each passageway can be designed independently of the material for another passageway. For example, passageway 114 can have a metal material of a certain porosity, while passageway 135 can have a non-metal material of a different porosity. Also, the material can be placed differently for each passageway. Complete design control is provided to allow any desired operation of the apparatus.

It should be noted that while FIG. 5 describes the use of a material to establish the flow rates in the two passageways, the present invention can be used to establish the flow rates in any number of passageways in an apparatus or a larger system.

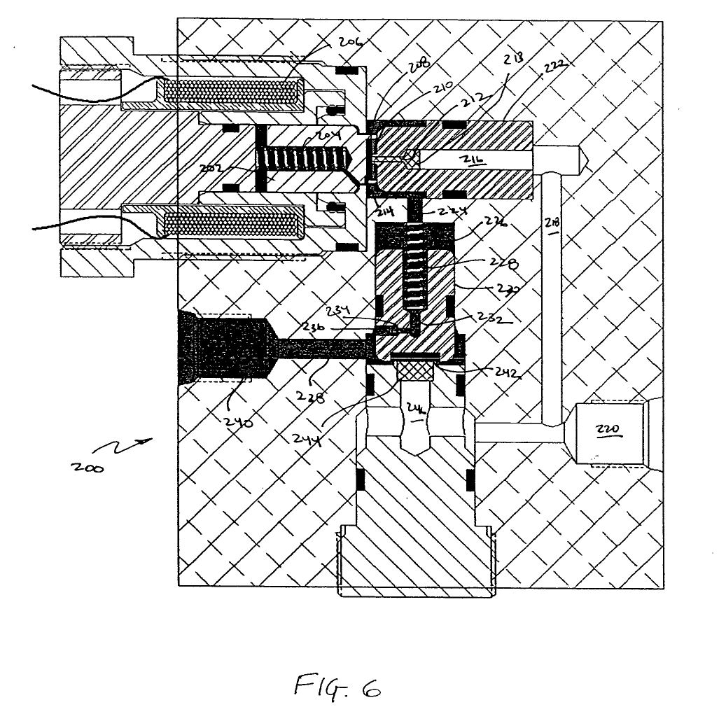

FIG. 6 illustrates a pilot-operated solenoid valve 200. The valve 200 is used to regulate a fluid in a high pressure container, such as 10,000 psi. As an example, the high pressure container may store an alternative fuel, such as hydrogen or compressed natural gas, for an alternative fuel vehicle. The container is connected to a module. The module can contain a microprocessor or be connected to a separate CPU. The module or CPU electronically controls the flow of the high pressure gas from the container through the valve to a fuel line. The fuel line delivers the alternative fuel to an engine. The engine can be an alternative fuel engine such as a hydrogen fuel cell.

The high pressure container communicates with valve 200 through passageway 240. FIG. 6 illustrates the valve 200 before the module activates the valve 200 for delivery of the gas to fuel line. In this state, the high pressure gas fills certain passageways and sections of the valve 200 as indicated by the dark shading. Other passageways of the valve 200 are not filled with the high pressure gas through the operation of seals 208 and 242. Seals 208 and 242 prevent high pressure gas from leaking into passageways 218 and 246 respectively and ultimately to outlet passageway 220. Outlet passageway 220 communicates with a fuel line to the engine.

The module or CPU activates the valve 200 for delivery of the high pressure gas to the fuel line by providing a signal to energize the armature 202. The armature 202 is energized by solenoid coils 206. The armature 202 overcomes the load provided by the high pressure gas and spring 204 to lift seal 208 from an annular extension 210 of pilot spool 222. As illustrated in FIG. 6, pilot spool 222 has a bleed orifice 212 communicating with a larger passageway 216. Bleed orifice 212 and a portion of the passageway 216 are filled with a porous metal 213 (indicated by the markings in FIG. 6). The porous metal is sintered 316 stainless steel. In bleed orifice 212, the porous metal 213 is filled so as to be closely aligned with the top surface of annual extension 210. The porous metal 213 provides support for the seal 208 when it rests on annular extension 210. The support that the porous metal 213 provides reduces the risk that seal 208 will be cut and/or abraded during the operation of valve 200 with high pressure gas.

The porous metal 213 also allows the gas to flow through the bleed orifice 212 and passageway 216. When the armature 202 is energized and seal 208 lifts, the high pressure gas bleeds through bleed orifice 212 and passageway 216, then through passageway 218 and finally through passageway 220. The bleeding of the gas reduces the pressure of the gas in certain passageways of valve 200. For example, prior to the energizing of armature 202, passageway 214, passageway 224 and the section of chamber 226 supporting spring 228 contain high pressure gas. As the gas is bled through bleed orifice 212, the pressure in these passageways or sections reduces.

As the gas is bled through bleed orifice 212, gas also bleeds through the main spool bleed orifice 234. As illustrated in FIG. 6, a material 232 is placed in the main spool bleed orifice 234. The material 232 is sintered 316 stainless steel. The porous metal 232 is designed to ensure that the flow rate in the main spool bleed orifice 234 is configured with the flow rate through the pilot spool bleed orifice 212 such that the main spool 230 overcomes its load. For example, porous metal 232 may have a different porosity than porous metal 213. The difference in porosity results in the flow rate through bleed orifice 212 being greater than the flow rate through the main spool bleed orifice 234. This creates a pressure drop in the area above the main spool 230 (such as where spring 228 is positioned), because gas is flowing out of the area at a greater rate than it can be replaced. The pressure drop causes the main spool 230 to overcome its load (including the load provided by spring 228).

The main spool 230 lifts through chamber 226. By lifting, the main spool 230 closes passageway 236 from passageways 240 and 238, while lifting seal 242. Once seal 242 is lifted, high pressure gas flows from passageway 240 through passageway 238 through passageway 246 and into passageway 220. In this manner, high pressure gas is delivered to the fuel line.

FIG. 6 illustrates that passageway 246 having a material 244. The material 244 is sintered 316 stainless steel. The porous metal 244 is designed to provide support to seal 242 when it is its resting (i.e., not lifted by the main spool 230). Furthermore, the porous metal 244 provides the required flow rate of the high pressure gas through passageway 246.

When the module or CPU determines that enough high pressure gas has been delivered to the fuel line, it provides a signal to de-energize armature 202. When armature 202 is de-energized, spring 204 urges seal 208 against the annular extension of pilot spool 222. This causes the gas in the bleed orifice 212, passageway 216 and passageway 218 to bleed through passageway 220. At the same time, the pressure of the gas in passageways such as passageways 214 and 224 increases. The increase in pressure removes the pressure differential at main bleed orifice 234, thereby allowing spring 228 to urge main spool 230 and seal 242 down. Seal 242 then closes off passageway 246 from passageways 240 and 238. The high pressure gas in passageway 246 bleeds off to outlet through passageway 220. The valve 200 then reaches its initial state as illustrated in FIG. 6.

Although FIG. 6 has been described in connection with a pilot operated solenoid valve in which the pilot spool and the main spool are separated, it is not limited to such valves. The present invention can be employed using pilot-operated solenoid valves where the pilot spool and the main spool are in different planes or where the pilot spool and the main spool are integrally connected. The present invention can be employed with direct acting solenoid valves. Moreover, the present invention is not limited to solenoid-operated valves. It can be used in other types of valves.

Although FIG. 6 has been described with the use of a gas, the present invention can be employed with any type of fluid, including a liquid. Furthermore, while FIG. 6 has been described in connection with an alternative fuel vehicle, it can be used with any type of motor vehicle including, but not limited to, motor vehicles having hybrid combustion/electrical engines or motor vehicles having standard combustion engines. It should be noted that present invention may also be used in stationary devices, such as refueling stations, or any other gas management systems.

Although FIG. 6 illustrates a valve in a high pressure environment, the present invention is not limited to high pressure environments. The present invention can be used in any environment, because its benefits, such as providing support and control over the flow in the system, are not limited to high pressure environments.

Although the present invention has been described in the context of a device for regulating the flow of a fluid, the present invention can be used in any other context in which a member must be supported and/or flow must be controlled.

Although the present invention has been fully described in connection with the preferred embodiments thereof with reference to the accompanying drawings, it is to be noted that various changes and modifications will become apparent to those skilled in the art. Such changes and modifications are to be understood as being included within the scope of the present invention.

What is claimed is:

1. An apparatus for regulating a fluid comprising:
a passageway having an opening through which the fluid flows;
a member operating between a first position and a second position to control the flow of the fluid through the passageway wherein, in said first position, the member is spaced from the opening to allow the fluid to flow through the passageway and wherein, in said second position, the member covers the opening to prevent the fluid from flowing through the passageway; and
at least one element positioned adjacent to the opening, said element comprising at least one material that supports the member when the member is in the second position.

2. The apparatus of claim 1 wherein said element is positioned within said opening.

3. The apparatus of claim 2 wherein said element extends throughout the length of the passageway.

4. The apparatus of claim 2 wherein said element extends across the width of the opening.

5. The apparatus of claim 1 wherein the material is porous through which the fluid flows.

6. The apparatus of claim 5 wherein the material is a metal.

7. The apparatus of claim 6 wherein the material is 316 stainless steel.

8. The apparatus of claim 5 further comprising:
a second passageway through which the fluid flows, said second passageway communicating with the first passageway; and
a second element positioned adjacent to the second passageway, said second element comprising at least a second material that allows the fluid to flow through the second passageway.

9. The apparatus of claim 8 wherein the material of the element is the same as the second material of the second element.

10. The apparatus of claim 8 wherein the material of the element has a different porosity than the second material such that a flow rate of the fluid in each passageway is different.

11. The apparatus of claim 1 wherein the fluid is a gas.

12. An alternative fuel vehicle comprising:
an engine operating on an alternative fuel;
a storage vessel storing the alternative fuel; and
at least one fuel line communicating with the engine and the storage vessel;
an apparatus for regulating the fuel between the storage vessel and the engine, wherein said apparatus comprises,
a passageway having an opening through which the fuel flows;
a member operating between a first position and a second position to control the flow of the fuel through the passageway wherein, in said first position, the member is spaced from the opening to allow the fuel to flow through the passageway and wherein, in said second position, the member covers the opening to prevent the fuel from flowing through the passageway; and
at least one element positioned adjacent to the opening, said element comprising at least one material that supports the member when the member is in the second position.

13. A method for regulating a fluid in at least one passageway, said passageway having an opening through which the fluid flows, said opening capable of being closed by a member, said method comprising:
selecting at least one material; and
associating the material with said opening such that the material supports the member when the opening is closed by the member.

14. The method of claim 13 wherein associating the material with said opening comprises placing the material within said opening.

15. The method of claim 13 wherein selecting at least one material comprises selecting at least one porous material through which the fluid flows.

16. The method of claim 15 further comprises:
selecting a second material; and
associating the second material with a second passageway.

17. The method of claim 16 wherein selecting a second material comprises selecting a second material having a different porosity than the material associated with said opening such that a flow rate of the fluid in each passageway is different.

18. A method of manufacturing an apparatus for regulating a fluid, said apparatus comprising a plurality of passageways through which a fluid flows, said method comprising:
determining a first flow rate of the fluid in a first passageway and a second flow rate of the fluid in a second passageway, said first and second passageways in communication with each other;
selecting a first material to place in the first passageway to obtain the first flow rate;
selecting a second material to place in the second passageway to obtain the second flow rate;
placing the first material in the first passageway; and
placing the second material in the second passageway.

19. The method of claim 18 wherein the step of selecting a second material comprises selecting a second material having a different porosity than the first material.

20. The method of claim 18 wherein the step of determining comprises correlating the first fluid flow rate with the second fluid flow rate such that a pressure drop is created between the first and second passageways.
